(19) United States
(12) Patent Application Publication
(10) Pub. No.: US 2024/0224345 A1
(43) Pub. Date: Jul. 4, 2024

(54) NETWORK REPOSITORY FUNCTION

(71) Applicant: DISH WIRELESS L.L.C., ENGLEWOOD, CO (US)

(72) Inventor: Jinsook Ryu, Oakton, VA (US)

(21) Appl. No.: 18/092,125

(22) Filed: Dec. 30, 2022

(51) Int. Cl. H04W 76/10; H04W 48/16

(52) U.S. Cl. CPC H04W 76/10; H04W 48/16

(57) ABSTRACT

A disclosed method may include (i) receiving, by a centralized unit-control plane node within a telecommunications network, an indication for a user equipment to establish a session at least in part by being assigned a centralized unit-user plane node, (ii) forwarding, by the centralized unit-control plane node to a radio access network repository function within a corresponding radio access network, centralized unit-user plane discovery information for the user equipment, (iii) receiving, from the radio access network repository function, in response to forwarding the centralized unit-user plane discovery information, identifying information for at least one centralized unit-user plane node, (iv) assigning, by the centralized unit-control plane node and based on the received identifying information for the at least one centralized unit-user plane node, a specific centralized unit-user plane node to the user equipment. Related systems and computer-readable mediums are further disclosed.

### BRIEF SUMMARY

This application is generally directed to a network repository function disposed within a radio area network, such as an open radio network (O-RAN). In one example, a method may include (i) receiving, by a centralized unit-control plane node within a telecommunications network, an indication for a user equipment to establish a session at least in part by being assigned a centralized unit-user plane node, (ii) forwarding, by the centralized unit-control plane node to a radio access network repository function within a corresponding radio access network, centralized unit-user plane discovery information for the user equipment, (iii) receiving, from the radio access network repository function, in response to forwarding the centralized unit-user plane discovery information, identifying information for at least one centralized unit-user plane node, (iv) assigning, by the centralized unit-control plane node and based on the received identifying information for the at least one centralized unit-user plane node, a specific centralized unit-user plane node to the user equipment.

In a further example, the centralized unit-control plane node selects, from among multiple candidate centralized unit-user plane nodes, the specific centralized unit-user plane node for the user equipment by finding a match between the centralized unit-user plane discovery information and the identifying information for the multiple candidate centralized unit-user plane nodes.

In a further example, the centralized unit-user plane discovery information includes at least one of a user equipment location, a requested slice type, or a quality of service specification for the session.

In a further example, the identifying information for at least one centralized unit-user plane node includes a list of multiple centralized unit-user plane nodes.

In a further example, the identifying information for at least one centralized unit-user plane node further specifies a condition for each one within a set of the multiple centralized unit-user plane nodes.

In a further example, the condition further specifies, for each one within the set, at least one of latency from a distributed unit or radio unit, load information, or edge computing capacity information.

In a further example, the method further includes forwarding bearer context information to the assigned specific centralized unit-user plane node.

In a further example, the method further includes, prior to the assigning, the specific centralized unit-user plane node registering with the radio access network repository function.

In a further example, the method further includes the specific centralized unit-user plane node receiving, in response to registering with the radio access network repository function, an indication that the registering succeeded.

In a further example, the specific centralized unit-user plane node registering with the radio access network repository function further includes the specific centralized unit-user plane node sending specific identifying information for the specific centralized unit-user plane node that indicates at least one of coverage, buffering capability, quality of service capability, or latency.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 shows a flow diagram for an example method relating to a network repository function.

FIG. 2 shows an example open radio area network architecture.

FIG. 3 shows an example workflow of communications between a centralized unit-control plane node and a centralized unit-user plane node.

FIG. 4 shows an example workflow of communications for a centralized unit-user plane node registering with a radio area network repository function.

FIG. 5 shows an example workflow of communications for a centralized unit-control plane node assigning a centralized unit-user plane node to a user equipment based on information obtained from a radio area network repository function.

FIG. 6 shows a flow diagram for an example method for selecting between different centralized unit-user plane nodes.

FIG. 7 shows a flow diagram for an example method for determining whether to perform an E1 setup as part of a procedure for assigning a centralized unit-user plane node to a user equipment.

FIG. 8 shows an illustrative example computing environment which may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

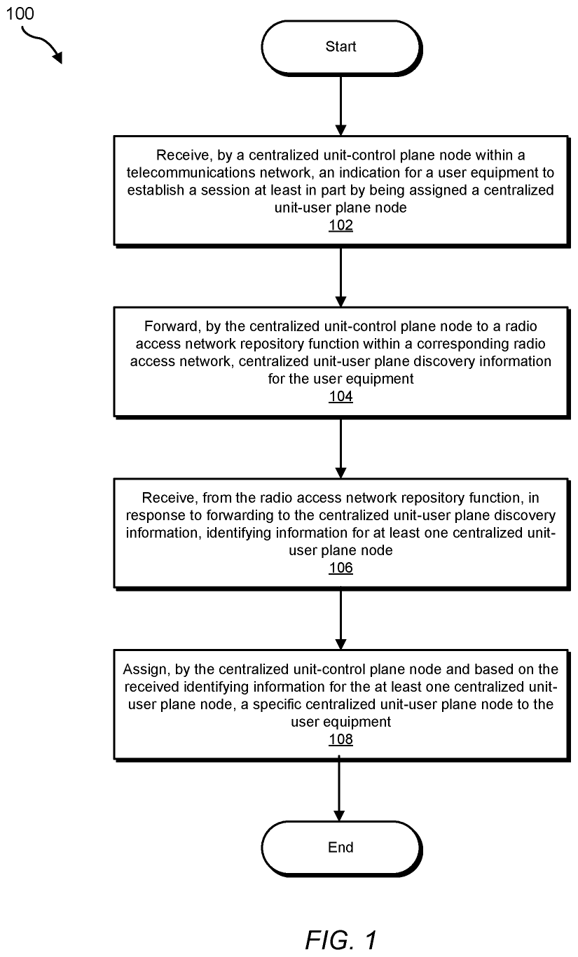

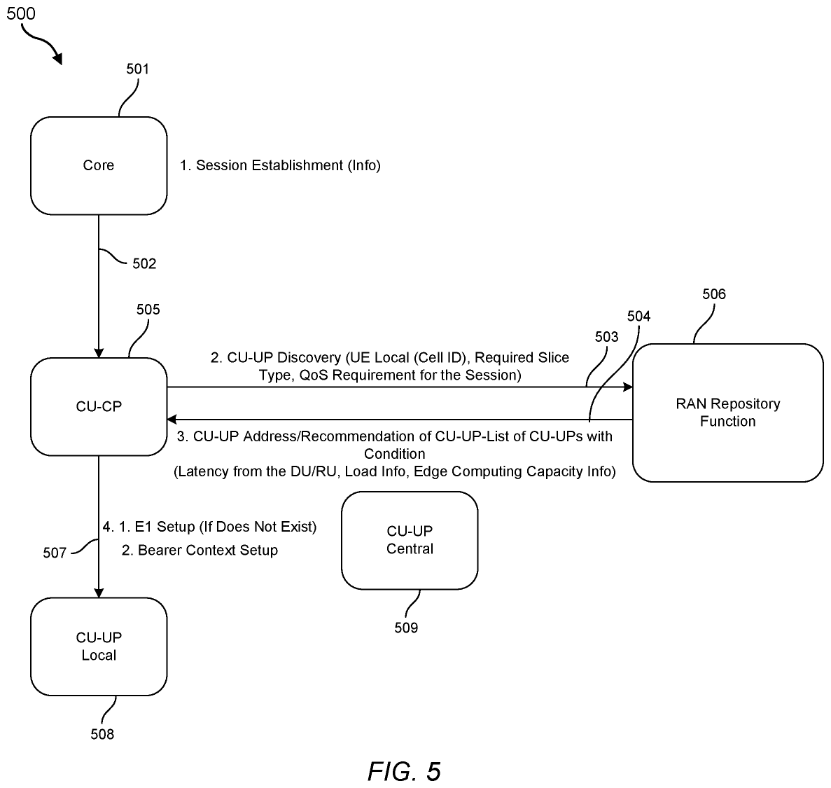

FIG. 1 shows a flow diagram for an example method 100 relating to a network repository function disposed within a radio access network. At step 102, a centralized unit-control plane node within a telecommunications network receives an indication for a user equipment to establish a session at least in part by being assigned a centralized unit-user plane node. At step 104, the centralized unit-control plane node may forward to a radio access network repository function within the corresponding radio access network, centralized unit-user plane discovery information for the user equipment. At step 106, the centralized unit-control plane node may receive, from the radio access network repository function, in response to forwarding the centralized unit-user plane discovery information, identifying information for at least one centralized unit-user plane node. And at step 108, the centralized unit-control plane node may assign, based on the received identifying information for the at least one centralized unit-plane node, a specific centralized unit-user plane node to the user equipment. Various embodiments, implementation details, and/or items of background contextual information regarding method 100 will be discussed in connection with the remaining figures, including FIG. 5, which shows a workflow of communication corresponding to method 100.

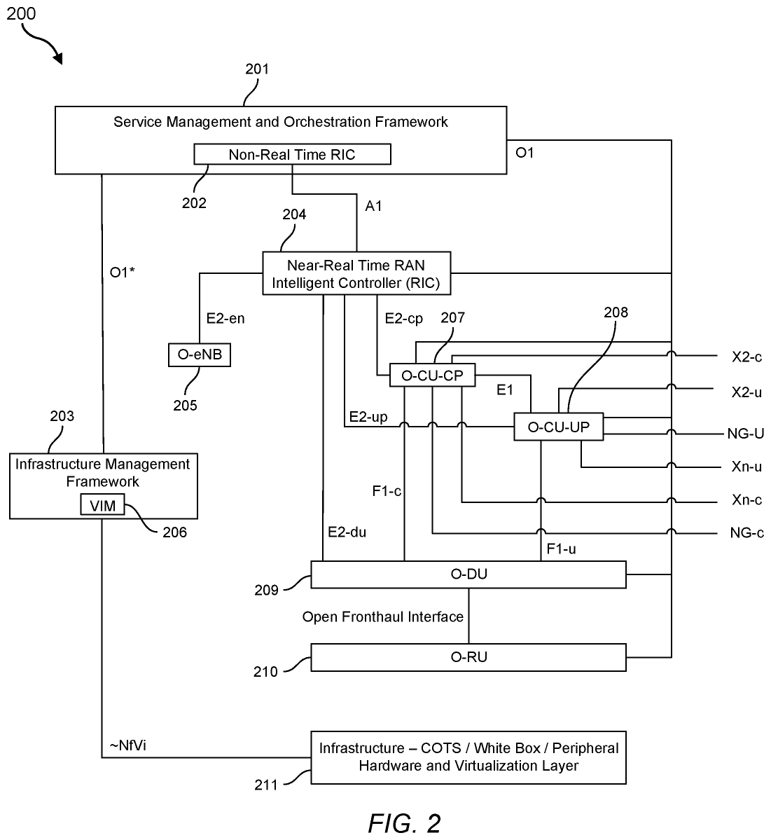

FIG. 2 shows an illustrative architecture 200 corresponding to the open radio access network (O-RAN) architecture. In this example, the open radio access network software community (O-RAN SC) architecture follows the O-RAN alliance defined architecture.

Architecture 200 may include a service management and orchestration framework 201, which may interface with three primary components, an infrastructure management framework 203, an infrastructure 211, and a near-real-time radio access network intelligent controller (RIC) 204. Service management and orchestration framework 201 may further include a non-real time radio access network intelligent controller (RIC) 202. Infrastructure management framework 203 may further include a virtualized infrastructure manager (VIM) 206. And near-real-time radio access network intelligent controller 204 may further communicate with an evolved NodeB (O-eNB) 205, which corresponds to the hardware aspect of a 4G radio access network. Near-real time radio access network intelligent controller 204 also further interfaces with a centralized unit-control plane node 207 and a centralized unit-user plane node 208, as well as a distributed unit 209, and a radio unit 210, as further shown in this figure. In various embodiments, the technology of this application may focus upon communications and interactions between centralized unit-control plane node 207 and centralized unit-user plane node 208. FIG. 2 also further illustrates how architecture 200 may further include a multitude of communication lines interconnecting various ones of the components outlined above.

In the context of FIG. 2, radio access network (e.g., gNB or base station) disaggregation corresponds to an initial phase of the deployment of 5G technology, and a major application will be Enhanced Mobile Broadband (eMMB). Radio access network disaggregation can be performed according to the 3rd Generation Partnership Project (3GPP) or according to the O-RAN specification illustrated in the example of FIG. 2.

In some examples, a centralized unit-user plane deployment can be disposed more within a central or middle located data center. Alternatively, the centralized unit-user plane deployment can be co-located as part of functioning of the core network (e.g., Access and Mobility Management Function or AMF, Session Management Function or SMF, and/or the User Plane Function or UPF) within the centralized unit-control plane. In these examples, in most cases a single centralized unit-control plane services a single centralized unit-user plane.

Nevertheless, in further examples, to support different types of services or network slices, the user plane function may require or request different capabilities, such as computational power or different buffering capacity. Additionally, or alternatively, the user plane function may require or request different characteristics, including eMBB, ultra-reliable low latency communications (URLLC), and/or Industrial Internet of Things (IIoT).

For slice isolation support, a separated centralized unit-user plane can require or request for a specific network slice. Due to latency, some centralized unit-user planes can be closer to the edge of the network as part of Mobile Edge Computing (MEC). The centralized unit-user plane may be co-located with a distributed unit to be closer to the attachment point of the user, in which case the centralized unit-user plane will be more localized. Additionally, for user plane scalability, a single centralized unit-control plane may serve many centralized unit-control planes based upon their capabilities, as discussed further below.

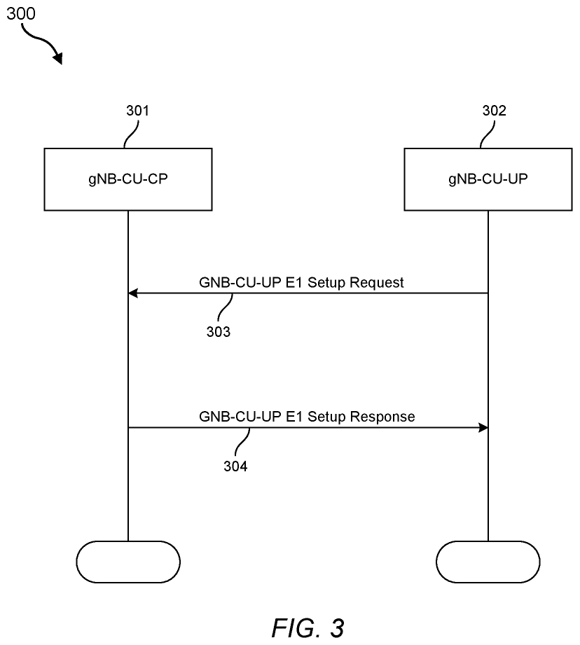

FIG. 3 shows an example workflow 300 corresponding to communications between a centralized unit-user plane node 302 and a centralized unit-control plane node 301 in various embodiments. At workflow step 303, centralized unit-user plane node 302 may transmit a setup request to establish a connection or session between centralized unit-user plane node 302 and centralized unit-control plane node 301. The setup request may be formatted according to the E1 Application Protocol (E1AP) defined by the TS 37.483 9.2.1.4 specification, for example. In response, centralized unit-control plane node 301 may transmit a response, at workflow step 304, an E1 setup response.

In these examples, the centralized unit-control plane may store centralized unit-user plane information. In various examples, one or more items of the stored centralized unit-user plane information may include a slice support list, a Cell Global Identifier (CGI) support list, a quality of service (QoS) parameter support list, and/or capacity information (i.e., for load-balancing). Additionally, or alternatively, in some examples the centralized unit-user plane can provide the latency information from the centralized unit-control plane, location information of the centralized unit-user plane (whether central or local), and/or the latency associated with the centralized unit-user plane.

In various examples, the centralized unit-control plane may use one or more of the above listed items of information to select (i.e., during session setup) a particular serving centralized unit-user plane for a particular user equipment for bearer (e.g., the Protocol Data Unit or PDU session and/or a quality of service flow) setup.

Nevertheless, the configurations of the various embodiments listed above in the context of FIG. 3 may be associated with one or more deficiencies. In particular, a one-to-one setup and discovery procedure may not be scalable. On the contrary, multiple centralized unit-control planes may request a setup for the same centralized unit-user plane. Accordingly, for better scalability and for an improved cloud computing environment, a distinct or improved centralized unit-user plane discovery procedure may be helpful, as discussed in more detail below in the context of FIGS. 3-7.

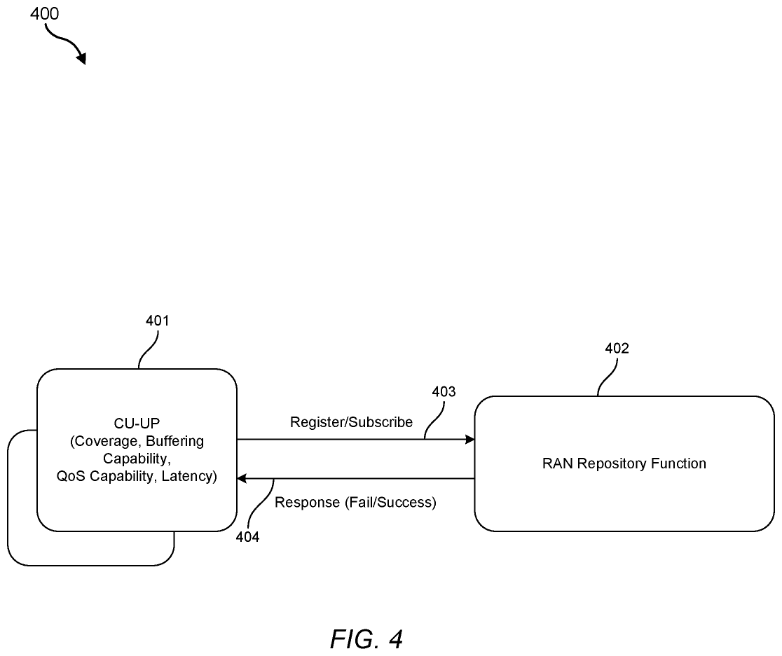

FIG. 4 shows an illustrative example of a workflow 400 corresponding to communications or interactions between a centralized unit-user plane node 401 and a radio access network repository function 402. FIG. 4 generally illustrates a procedure for the centralized unit-user plane to register with the radio access network repository function. Instead of the centralized unit-user plane requesting setup with a centralized unit-control plane according to the E1AP protocol (discussed above in the context of FIG. 3), the centralized unit-user plane may use the discovery procedure consistent with the registration workflow of FIG. 4 in connection with radio access network repository function 402.

Radio access network repository function 402 may correspond to an improvement that addresses one or more of the deficiencies outlined above with respect to the configuration of FIG. 3. Radio access network repository function 402 may be, in some senses, analogous to the network repository function associated with one or more embodiments of the configuration of FIG. 3. Generally speaking, the configuration of FIG. 4 represents a scenario where analogous functionality of the network repository function for the core network has been intelligently relocated within the radio access network, thereby relocating this functionality closer to the user equipment attempting to establish a session.

As further shown in FIG. 4, workflow 400 may include centralized unit-user plane node 401 transmitting a register/subscribe message at step 403 to radio access network repository function 402. Centralized unit-user plane node 401 may transmit, as part of this register/subscribe message, one or more items of identifying information for the centralized unit-user plane node (i.e., the specific centralized unit-user plane node of method 100). This identifying information may indicate at least one of coverage, buffering capability, quality of service capability, or latency). In this manner, the centralized unit-user plane node 401 effectively notifies radio access network repository function 402 of one or more capabilities, characteristics, features, and/or attributes of centralized unit-user plane 401. Thus, when one or more items of user equipment attempt to establish a session with the network, the corresponding centralized unit-control plane may solicit or retrieve these items of identifying information in order to perform the matching, selecting, and/or assigning procedure of method 100 to thereby match the requesting user equipment to a corresponding centralized unit-user plane node, as discussed in more detail below.

FIG. 4 also further illustrates how, in response to the register/subscribe message at step 403, centralized unit-user plane node 401 may receive a response message at step 404, which may further indicate whether the attempt to register/subscribe with radio access network repository function 402 failed or succeeded. In the case that centralized unit-user plane node 401 is actually assigned to the user equipment of method 100, then centralized unit-user plane node 401 will have succeeded in registering/subscribing previously with radio access network repository function 402, such that the centralized unit-control plane is enabled to retrieve the identifying information and perform the matching procedure of method 100.

In other words, method 100 may further include prior to the assigning of the specific centralized unit-user plane node, a step of the specific centralized unit-user plane node registering with the radio access network repository function. Moreover, in these examples, method 100 may also further include the specific centralized unit-user plane node receiving, in response to registering with the radio access network repository function, an indication that the registering succeeded. Additionally, or alternatively, method 100 may also further include the specific centralized unit-user plane node sending specific identifying information for the specific centralized unit-user plane node that indicates at least one of coverage, buffering capability, quality of service capability, or latency.

FIG. 5 shows a more detailed and illustrative workflow 500 that generally outlines one or more features of the establishment of a session corresponding to the methodology of FIG. 1, as further discussed above. As further shown in this figure, workflow 500 may outline one or more interactions between various components, including a core 501, a centralized unit-control plane node 505, a radio access network repository function 506, a local centralized unit-user plane node 508, and/or a central centralized unit-user plane 509. At step 502, an item of user equipment may attempt to establish a session with the network by first connecting with core 501. Subsequently, at step 502, core 501 may notify centralized unit-control plane node 505 about the specific attempt by the user equipment to establish the session. In response, centralized unit-control plane node 505 may initiate a procedure to assign a specific centralized unit-user plane node, such as local centralized unit-user plane node 508 to the user equipment consistent with method 100. In particular, centralized unit-control plane node 505 may perform method 100 to select between different available or candidate centralized unit-user plane nodes, such as the set of two centralized unit-user plane nodes shown in FIG. 5 (i.e., local centralized unit-user plane node 508 and central centralized unit-user plane node 509). In other words, in these examples the centralized unit-control plane node can select, from among multiple candidate centralized unit-user plane nodes, the specific centralized unit-user plane node for the user equipment by finding a match between the centralized unit-user plane discovery information and the identifying information for the multiple candidate centralized unit-user plane nodes.

At step 503, centralized unit-control plane node 505 may transmit a message as part of centralized unit-user plane discovery procedures. The message transmitted at step 503 may include one or more items of centralized unit-user plane discovery information, which can provide context or relevant data which centralized unit-control plane node 505 can evaluate in order to select a specific centralized unit-user plane node from among multiple candidate centralized unit-user plane nodes, as further discussed above. As further shown in this figure, the centralized unit-user plane discovery information can include at least one of a user equipment location, a requested slice type, and/or a quality of service specification for the session.

Subsequently, in response to step 504, radio access network repository function 506 can transmit a response message. The response message may include identifying information for at least one centralized unit-user plane node in accordance with step 106 of method 100.

In some examples, the identifying information for at least one centralized unit-user plane node can further include a list of multiple centralized unit-user plane nodes. As further shown in FIG. 5, the identifying information for at least one centralized unit-user plane node can further specify a condition for each one within a set of multiple centralized unit-user plane nodes. In the illustrative example of FIG. 5, the set of multiple centralized unit-user plane nodes can include local centralized unit-user plane node 508 and/or central centralized unit-user plane node 509. For purposes of simplicity and explanation, the illustrative example of workflow 500 shown in FIG. 5 may only include the two instances of centralized unit-user plane node outlined above, but in other examples a larger multitude of different centralized unit-user plane nodes, and different types of centralized unit-user plane nodes, may be referenced in connection with the performance of method 100.

FIG. 5 also further illustrates how the identifying information for at least one centralized unit-user plane node can further specify a condition for each one within a set of the multiple centralized unit-user plane nodes. In some examples, the condition further specifies, for each one within the set, at least one of latency from a distributed unit or radio unit, load information, or edge computing capacity information.

Although the illustrative example of workflow 500 corresponds to a scenario where centralized unit-control plane node 505 performs method 100, in other examples radio access network repository function 506 may perform some, or all, of the selection procedure corresponding to method 100. In other words, some or all of the selecting functionality of method 100 may be offloaded from centralized unit-control plane node 505 onto one or more portions of radio access network repository function 506 in these examples.

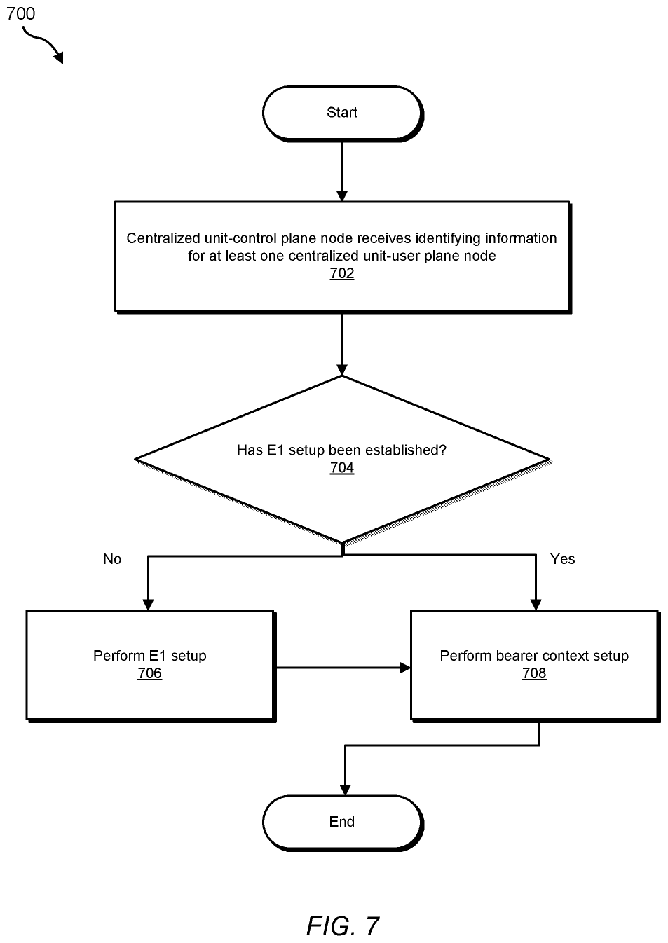

At step 507 in workflow 500, a bearer context setup procedure may be performed. The bearer context may correspond to a block of information within the centralized unit-user plane node that is associated with the particular user equipment requesting the session with the network. The bearer context block of information can be used for the sake of communication over the E1 interface, for example. Additionally, in a scenario where an E1 configuration setup has not previously been established, then the E1 setup procedure associated with FIG. 3 may be performed, as discussed further below in more detail in connection with FIG. 7.

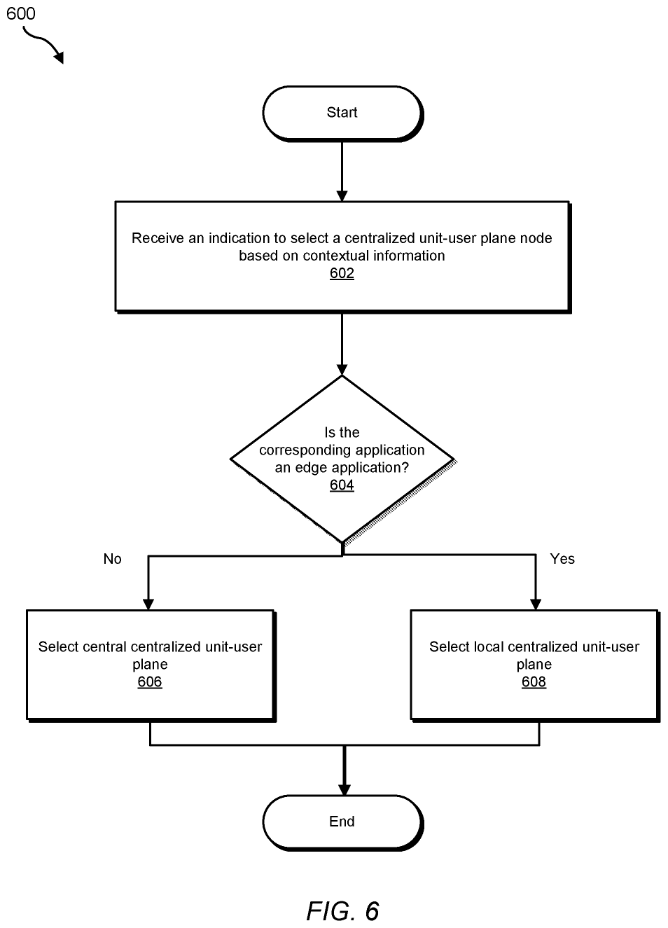

FIG. 6 shows an illustrative flow diagram for a method 600 that helps to outline an example of how the centralized unit-control plane node may intelligently select from among multiple candidate centralized unit-user plane nodes, the specific centralized unit-user plane node to assign to the user equipment based on one or more of the items of textual information retrieved from the radio access network repository function. The example of FIG. 6 focuses on selection between a local centralized unit-contextual user plane node (e.g., node 508 in FIG. 5) and a central centralized unit-user plane node (e.g., node 509 in FIG. 5), but in other examples different forms of decisions (i.e., not just a decision between local or central) may be performed on one or more of the items of contextual information transmitted at step 504 of workflow 500, consistent with the discussion of FIG. 5 above.

At step 602, the centralized unit-control plane node may receive an indication to select a centralized unit-user plane node based on contextual information. For example, at step 502 of workflow 500, centralized unit-control plane node 505 may receive the message transmitted by core 501 as part of workflow 500. This message may indicate that a particular user equipment is attempting to establish a session with the network. The message transmitted at step 502 may also further forward contextual information from the user equipment identifying one or more characteristics of the user equipment and/or associated information indicating one or more preferences or requests of the user equipment, for example. Based on this received information from core 501 at step 502, centralized unit-control plane node 505 may perform an embodiment of method 100 to intelligently select between different available candidate centralized unit-user plane nodes, and in particular between a local such node and a central centralized unit-user plane node, as further illustrated in FIG. 5.

Returning to FIG. 6, at decision step 604, the centralized unit-control plane node may inquire whether the corresponding application constitutes, or includes, an edge application. An edge application may refer to an application executing as part of a distributed computing framework that brings enterprise or other applications closer to data sources such as Internet of things devices or local edge servers. Additionally, or alternatively, edge computing can refer to a distributed information technology architecture in which client data is processed at the periphery of a network. In view of the above, if the decision is no at decision step 604, then the centralized unit-control plane node may select a central centralized unit-user plane node at step 606 of method 600. Alternatively, if the decision is yes at decision step 604, then the centralized unit-control plane node may select the local centralized unit-user plane node at step 608 of method 600. Subsequently, method 600 may end.

FIG. 7 shows another illustrative flow diagram for a method 700 that corresponds to step 507 of workflow 500 shown in FIG. 5. At step 702, the centralized unit-control plane node receives identifying information for at least one centralized unit-user plane node. Step 702 may correspond to step 106 of method 100 and step 504 of workflow 500. Subsequently, at decision step 704, the centralized unit-control plane may inquire whether E1 setup has been previously established. If the decision is no at step 704, then at step 706, the corresponding setup procedure may be performed, as further discussed above. Alternatively, if the decision is yes at step 704, then method 700 may proceed directly to step 708, where a bearer context setup procedure is performed. Subsequently, method 700 may end.

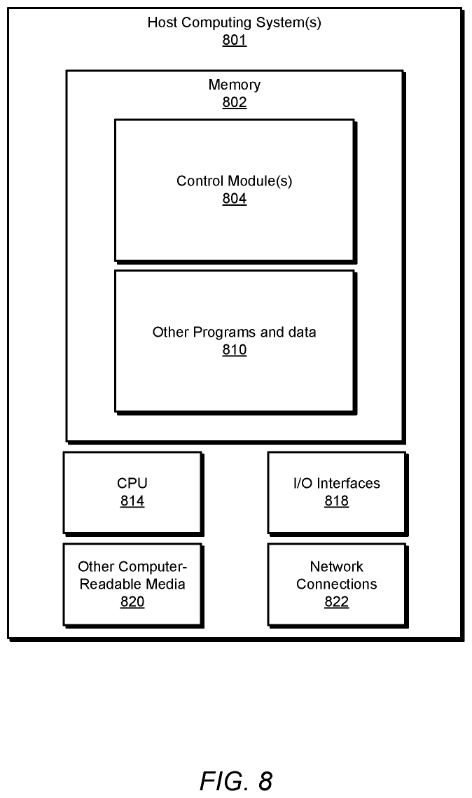

FIG. 8 shows a system diagram that describes an example implementation of a computing system(s) for implementing embodiments described herein. The functionality described herein relating to a network repository function can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 8 illustrates an example of underlying hardware on which such software and functionality may be hosted and/or implemented.

In particular, shown is example host computer system(s) 801. For example, such computer system(s) 801 may execute a scripting application, or other software application, to perform method 100, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems or components described herein relating to a network repository function. Memory 802 may also store other programs and data 810, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a centralized unit-control plane node within a telecommunications network, an indication for a user equipment to establish a session at least in part by being assigned a centralized unit-user plane node;
forwarding, by the centralized unit-control plane node to a radio access network repository function within a corresponding radio access network, centralized unit-user plane discovery information for the user equipment;
receiving, from the radio access network repository function, in response to forwarding the centralized unit-user plane discovery information, identifying information for at least one centralized unit-user plane node; and
assigning, by the centralized unit-control plane node and based on the received identifying information for the at least one centralized unit-user plane node, a specific centralized unit-user plane node to the user equipment.

2. The method of claim 1, wherein the centralized unit-control plane node selects, from among multiple candidate centralized unit-user plane nodes, the specific centralized unit-user plane node for the user equipment by finding a match between the centralized unit-user plane discovery information and the identifying information for the multiple candidate centralized unit-user plane nodes.

3. The method of claim 1, wherein the centralized unit-user plane discovery information comprises at least one of a user equipment location, a requested slice type, or a quality of service specification for the session.

4. The method of claim 1, wherein the identifying information for at least one centralized unit-user plane node comprises a list of multiple centralized unit-user plane nodes.

5. The method of claim 4, wherein the identifying information for at least one centralized unit-user plane node further specifies a condition for each one within a set of the multiple centralized unit-user plane nodes.

6. The method of claim 5, wherein the condition further specifies, for each one within the set, at least one of latency from a distributed unit or radio unit, load information, or edge computing capacity information.

7. The method of claim 1, further comprising forwarding bearer context information to the assigned specific centralized unit-user plane node.

8. The method of claim 1, further comprising, prior to the assigning, the specific centralized unit-user plane node registering with the radio access network repository function.

9. The method of claim 8, further comprising the specific centralized unit-user plane node receiving, in response to registering with the radio access network repository function, an indication that the registering succeeded.

10. The method of claim 8, wherein the specific centralized unit-user plane node registering with the radio access network repository function further comprises the specific centralized unit-user plane node sending specific identifying information for the specific centralized unit-user plane node that indicates at least one of coverage, buffering capability, quality of service capability, or latency.

11. A non-transitory computer-readable medium encoding instructions that, when executed by at least one physical processor of a computing device, cause the computing device to perform a method comprising:
receiving, by a centralized unit-control plane node within a telecommunications network, an indication for a user equipment to establish a session at least in part by being assigned a centralized unit-user plane node;
forwarding, by the centralized unit-control plane node to a radio access network repository function within a corresponding radio access network, centralized unit-user plane discovery information for the user equipment;
receiving, from the radio access network repository function, in response to forwarding the centralized unit-user plane discovery information, identifying information for at least one centralized unit-user plane node; and
assigning, by the centralized unit-control plane node and based on the received identifying information for the at least one centralized unit-user plane node, a specific centralized unit-user plane node to the user equipment.

12. The non-transitory computer-readable medium of claim 11, wherein the instructions are configured such that the centralized unit-control plane node selects, from among multiple candidate centralized unit-user plane nodes, the specific centralized unit-user plane node for the user equipment by finding a match between the centralized unit-user plane discovery information and the identifying information for the multiple candidate centralized unit-user plane nodes.

13. The non-transitory computer-readable medium of claim 11, wherein the centralized unit-user plane discovery information comprises at least one of a user equipment location, a requested slice type, or a quality of service specification for the session.

14. The non-transitory computer-readable medium of claim 11, wherein the identifying information for at least one centralized unit-user plane node comprises a list of multiple centralized unit-user plane nodes.

15. The non-transitory computer-readable medium of claim 14, wherein the identifying information for at least one centralized unit-user plane node further specifies a condition for each one within a set of the multiple centralized unit-user plane nodes.

16. The non-transitory computer-readable medium of 15, wherein the condition further specifies, for each one within the set, at least one of latency from a distributed unit or radio unit, load information, or edge computing capacity information.

17. The non-transitory computer-readable medium of claim 11, wherein the instructions are configured such that the method further comprises forwarding bearer context information to the assigned specific centralized unit-user plane node.

18. A system comprising:
a centralized unit-control plane node;
a specific centralized unit-user plane node; and
a radio access network repository function disposed within a corresponding radio access network;
wherein the centralized unit-control plane node is configured to perform a method comprising:
receiving, by the centralized unit-control plane node within a telecommunications network, an indication for a user equipment to establish a session at least in part by being assigned a centralized unit-user plane node;
forwarding, by the centralized unit-control plane node to the radio access network repository function within a corresponding radio access network, centralized unit-user plane discovery information for the user equipment;
receiving, from the radio access network repository function, in response to forwarding the centralized unit-user plane discovery information, identifying information for at least one centralized unit-user plane node; and
assigning, by the centralized unit-control plane node and based on the received identifying information for the at least one centralized unit-user plane node, the specific centralized unit-user plane node to the user equipment.

19. The system of claim 18, wherein the system is configured such that the centralized unit-control plane node selects, from among multiple candidate centralized unit-user plane nodes, the specific centralized unit-user plane node for the user equipment by finding a match between the centralized unit-user plane discovery information and the identifying information for the multiple candidate centralized unit-user plane nodes.

20. The system of claim 19, wherein the system is configured such that the centralized unit-user plane discovery information comprises at least one of a user equipment location, a requested slice type, or a quality of service specification for the session.
